(19) United States
(12) Patent Application Publication
(10) Pub. No.: US 2012/0296792 A1
(43) Pub. Date: Nov. 22, 2012

(54) Process for financing and interest rate price discovery utilizing a centrally-cleared derivative

(76) Inventors: Jeffrey Levoff, Chicago, IL (US); Donald R. Wilson, JR., Chicago, IL (US); Yuhau Yu, Chicago, IL (US)

(21) Appl. No.: 13/068,768

(22) Filed: May 18, 2011

(51) Int. Cl. G06Q 40/00

(52) U.S. Cl. 705/37

(57) ABSTRACT

A process for financing and interest rate price discovery utilizing a centrally-cleared derivative is provided. Criteria are bid and/or offered with respect to enumerated amounts. The criteria can be prices or interest rates. The interest rate can be an overnight and other term interest rates, forward interest rates, and combinations thereof. Bids and offers are matched at the same criteria rate. Each matched bid and offer is assigned at least one derivative at a price derived from the matched criteria. The derivative is centrally cleared.

### FIELD OF THE INVENTION

The present invention relates to financial instruments and to the electronic trading, delivering, clearing, and settling of such financial instruments.

### BACKGROUND OF THE INVENTION

Many different types of financial instruments are traded throughout the world. Examples include equities, bonds, cash contracts, and derivatives. The attributes of equities and bonds are generally well known. A cash contract is an agreement to deliver the specified asset. A derivative is a financial instrument whose value is linked to the price of an underlying commodity, asset, rate, index, currency or the occurrence or magnitude of an event. Typical examples of derivatives include futures, forwards, options, and swaps.

Swaps have traditionally been customized financial instruments that are traded in the over-the-counter (OTC) market. The OTC market most commonly refers to privately negotiated trades between two parties that are not centrally cleared (i.e. uncleared). Each party looks solely to the other party for performance and is thus exposed to the credit risk of the other party (this risk is often referred to as counterparty risk). There is no independent guarantor of performance. Uncleared swaps and other uncleared financial instruments are often transacted pursuant to International Swaps and Derivatives Association (ISDA) master documentation. The ISDA, 360 Madison Avenue, 16^{th} Floor, New York, N.Y. 10017 is an association formed by the privately negotiated derivatives market and represents participating parties.

When a trade is centrally cleared, the credit and performance risk of the parties to a trade to each other is removed. Stated differently, the parties to a trade are not counterparties to one another. Each party faces a clearinghouse and looks solely to the clearinghouse for performance. A clearinghouse is an agency of an exchange or separate entity responsible for settling and clearing trades, collecting and maintaining margin, regulating delivery, and reporting trading data.

While swaps have traditionally been uncleared, recently there has been pressure to migrate swaps to central clearing, including mandates set forth in the Dodd-Frank Wall Street Reform and Consumer Protection Act (the “Dodd-Frank Act”) (Pub.L. 111-203, H.R. 4173) signed into law by President Obama on 21 Jul. 2010. As a result of political pressure for greater transparency of uncleared financial instruments, the Dodd-Frank Act was passed into law in the wake of the 2008 financial crisis. During the 2008 financial crisis, many participants in uncleared financial instruments faced counterparties that were unable to meet their obligations.

Since enactment of the Dodd Frank Act, the Commodity Futures Trading Commission (CFTC) and the Securities Exchange Commission (SEC) have proposed a multitude of rules on specific topics, including mandatory centralized clearing, capital requirements of certain types of market participants, and transparency through execution of trades on the central limit order book of a transaction facility. Rules have also been proposed concerning segregation of cash balances, depending on whether a financial instrument is executed on an exchange or a swap execution facility (SEF), and the resulting protections associated with such segregation. Along with the rules on segregation is a proposal to restrict the types of investments that futures commission merchants (FCMs) can make with customer funds and cash balances. While these rules are still proposals, it is clear that many formerly accepted protections, procedures, and investments applicable to cash balances held with FCMs and brokers will change.

While swaps have traditionally been uncleared, certain uncleared financial instruments can be submitted to a clearinghouse for central clearing. Once the trade is accepted by a clearinghouse, the counterparty risk is eliminated. Just as with exchange traded instruments, both parties to a trade face the clearinghouse and look solely to the clearinghouse for performance. For example, on the CME Group's ClearPort facility, 20 South Wacker Drive, Chicago, Ill. 60606, OTC trades in certain financial instruments may be converted into futures or futures options, upon acceptance by CME's clearinghouse. In effect, these OTC financial instruments go through a transformation into cleared futures or futures options. Other financial instruments may be accepted by a clearinghouse for central clearing, but do not convert into futures. In both case, like all centrally-cleared trades, the counterparty risk between parties to the trade is eliminated.

Because of the different ways that collateral is treated for cleared and uncleared financial instruments, unless an adjustment is made, cleared and uncleared financial instruments with the same coupon and maturity may have different values. Clearinghouses apply a concept known as variation margin to cleared futures and similar cleared financial instruments. The clearinghouse requires the party that has an unrealized loss on a position in a cleared financial instrument to post margin equal to the amount of the loss, and that amount is credited to the party that has a profit. The party that receives the variation margin is the owner of that money and can receive interest on or otherwise invest it. On the other hand, for an uncleared trade, the party who has an unrealized loss on the trade normally posts collateral with its counterparty, the party that has a corresponding gain on the uncleared instrument. The standard practice is that the collateral remains the property of the party posting the collateral, and all interest received on the collateral is for the benefit of the party posting the collateral. These very different treatments of collateral in the cleared and uncleared context can cause otherwise similar cleared and uncleared financial instruments to have different values. This difference in value is in part dependent on both the interest that market participants can receive on funds and the correlation between the instrument and interest rates in general.

To facilitate the transition of uncleared instruments to central clearing, there have been various efforts to construct cleared financial instruments such that they will transact and settle to a value equal to their uncleared counterparts. One attempt to address this issue was the introduction of the “Price Alignment Interest” (PAI) in 2008 on the SwapClear Facility of LCH.Clearnet, Aldgate House, 33 Aldgate High Street, London EC3N 1EA U.K. (LCH.Clearnet is an independent clearinghouse serving exchanges and trading platforms, as well as a range of OTC markets; SwapClear is a service for the central clearing of OTC interest-rate swaps.) Counterparties initially enter into a bilateral interest-rate swap and subsequently submit the swap for clearing through LCH.Clearnet.

LCH.Clearnet introduced PAI in an attempt to eliminate the difference in the value between cleared and uncleared swaps with similar terms. As noted in the LCH.Clearnet rules, “[t]he payment of variation margin, or change in NPV [net present value], on a daily basis without adjustment would distort the pricing for swaps cleared through the Clearing House.” LCH.Clearnet Rule 2C.6.4. To attempt to address this distortion, LCH.Clearnet charges interest on cumulative variation margin received and pays interest on cumulative variation margin paid. PAI adjustments require that a particular interest rate be referenced in the computation.

Eris Exchange, 311 South Wacker Drive, Suite 950, Chicago, Ill. 60606, a futures exchange operating as an exempt board of trade under the jurisdiction of the CFTC, lists cleared interest-rate swap futures and has also addressed the issue of the difference in value. Instead of using the PAI concept, Eris Exchange has listed interest-rate swap futures with a terminal value that adjusts for interest received and paid on variation margin over the life of the interest-rate swap future. (http://www.erisfutures.com/contract-specifications-summary, visited on 12 May 2011.) The CME has also developed a cleared swap offering that uses a PAI adjustment. (http://www.cmegroup.com/trading/interest-rates/cleared-otc/index.html, visited on 12 May 2011.)

Each of these solutions requires the use of an overnight interest rate for the purpose of computing either the PAI adjustment—in the case of the LCH and CME—or the terminal value computation—in the case of Eris. The overnight interest rate of choice has been in flux since the financial crisis of 2008. Prior to 2008, London InterBank Offered Rate (LIBOR) was widely used. LIBOR is a daily reference rate based on the interest rates at which banks borrow unsecured funds from other banks in the London wholesale money market (or interbank lending market). LIBOR is fixed on a daily basis by the British Bankers' Association, a trade association which represents the banks operating within the United Kingdom. Individual LIBOR rates are the end product of a calculation based upon submissions from a panel made up of the largest, most-active banks.

The LCH switched to reference the Federal Funds Effective rate in 2008, and Eris and CME both reference the Federal Funds Effective rate. The Federal Funds Effective rate is the interest rate at which a depository institution lends immediately available funds to another depository institution overnight.

Furthermore, platforms on which swaps, including interest-rate swaps, are listed and/or cleared often ascribed a value to the swaps (i.e. settlement price) on a periodic basis, most often daily. In order to value a swap (or a swap future), the net present value of future cash flows must be determined. This requires discounting such cash flows to term interest rates that match up with the dates of the cash flows. Once again, the appropriate interest rate must be selected for this purpose. Similar to the overnight rate used for the PAI computation, the LIBOR rate was widely used prior to 2008; however, more recently most cleared swap products have gradually been migrating away from LIBOR towards using the overnight index swap (OIS) rate. The OIS rate is equal to the geometric average of an overnight index (i.e., a published interest rate) over every day of the payment period. In the United States, OIS rates are calculated by reference to daily Federal Funds Effective rate. LCH and Eris both use OIS rates, while currently the CME uses the LIBOR rate for the settlement process computation.

While generally regarded as a better proxy than LIBOR, the Federal Funds Effective rate does not necessarily represent the rate at which market participants actually receive and pay interest on a periodic basis. A even better proxy for adjusting and valuing cleared financial instruments would be to reference the actual rate at which market participants can invest funds held at an FCM or broker. However, no such readily tradable rate exists.

As discussed above, exchanges and clearinghouses use either the OIS or the LIBOR as a reference rate. The Federal Funds Effective rate/OIS curve is thinly traded, difficult for market participants to access, and sparsely reported, thus raising questions about its accuracy. LIBOR rates have credibility issues: LIBOR rates are set by large financial institutions, some of which are currently under investigation for allegedly colluding to manipulate LIBOR rates. See, e.g., “U.S. Asks if Banks Colluded on LIBOR”, Wall Street Journal, 14 Apr. 2011 (available at http://online.wsj.com/article/SB10001424052748704547804 576261120293347088.html, visited 15 May 2011).

In addition to the lack of a rate to effectively adjust and settle cleared financial instruments, participants in the financial markets are currently curtailed in managing their cash balances. Cash balances in futures accounts are commonly known as “total equity”. Market participants generally receive interest on positive cash balances and pay interest on negative cash balances. Total equity is defined as:

Total equity=net option premium+cash+open trade equity,

where open trade equity is the amount by which open futures trades or cleared swaps have profit and loss.

It is important to understand option premium in the context of total equity. Most options in the United States are “premium up-front” options. This means that the buyer of the option pays the seller the full amount of the option at the time the trade is effected. There are also “futures style” options where no option premium is paid at the time of a trade; rather, these options are margined similarly to futures, with an initial margin and subsequent variation margin. Premium up-front options fit into total equity as “net option premium”, while the profit and loss from futures style options flows through the open trade equity part of the definition.

Total equity is not to be confused with “net liquidating value”. Net liquidating value is the value of the account if all positions were liquidated at the previous day's settlement. Total equity may equal net liquidating value; however, in the case of an account that holds positions in premium upfront options, total equity will not equal net liquidating value.

Securities accounts have an entry similar to total equity. In the U.S., this is often referred to as “assessed balance”. Assessed balance includes cash deposits, net option premium, dividends, interest, and the purchase price paid for any securities in the account. Assessed balance generally does not include the proceeds of short stock sales. Account holders may receive interest on total equity and assessed balance. The rate at which interest is received is negotiated between the account holder and its clearing firm (FCM for a futures account or broker-dealer for a securities account). In securities and futures accounts, the rate at which the account holder receives or pays interest is a spread below or above a reference rate. For example, the benchmark rate may be the Federal Funds Effective overnight rate, and the spread may be 25 basis points. If the Federal Funds Effective rate is 1.00%, the rate at which the market participant would receive interest each night on its credit total equity or assessed balance would be 0.75%, and the rate at which the market participant would pay interest on debit balances would be 1.25%.

There is currently no convenient, liquid mechanism for market participants to trade with one another to receive or pay a better interest rate on their total equity and assessed balance. Take the following example: Party A has a debit total equity balance of $1,000,000, and party B has a credit total equity balance of $1,000,000. On its debit total equity, Party A pays its FCM the overnight Federal Funds Effective rate plus 25 basis points (i.e. 0.25%); on its credit total equity, Party B receives from its FCM the overnight Federal Funds Effective rate minus 25 basis points (i.e. 0.25%). If an overnight Federal Funds Effective rate is 1.00% (100 basis points), Party A pays 1.25% on its debit total equity of $1,000,000 and Party B receives 0.75% on its credit total equity of $1,000,000. If there were a financial instrument for Party A and Party B to conveniently trade, then Party A could pay less interest and Party B could receives more. They would likely trade at a rate around the Federal Funds Effective rate. In this example, each party would be better off by nearly $2,500 on an annual basis ($1,000,000×0.25%).

Finally, a broad group of parties use instruments tied to OIS, LIBOR, and Federal Funds Effective rates, such as interest rate swaps and Eurodollar futures, to hedge risks associated with interest rates. As discussed above, Federal Funds Effective, OIS and LIBOR rates have issues that raise question their credibility and accuracy. Market participants could find their needs better served through the establishment of an alternative benchmark rate, with greater transparency and broader participation. Such a benchmark rate would need to have a variety of different maturities and tradable instruments for overnight and other term rates, and forward rates.

In summary, it would be desirable to offer tools that allow for price discovery of interest rates. These tools could be used to manage overnight and other term rates, and forward interest rate risk. These tools could also be used as a reference rate for PAI and to adjust interest on variation margin on cleared swaps and swap futures. In addition, these tools could be used by FCMs and market participants to manage cash balances. These tools could also enable exchanges and clearinghouses to better discount future cash flows in order to determine interim settlement prices for cleared financial instruments that require discounting for fair valuation.

### SUMMARY OF THE INVENTION

The present invention allows for price discovery of interest rates. The present invention can be used to manage overnight and other term rate risk, and forward interest rate risk. The present invention can be used as a reference rate for PAI and to adjust interest on variation margin on cleared swaps and swap futures. The present invention can be used by FCMs and market participants to manage cash balances. The present invention also enables exchanges and clearinghouses to better discount future cash flows in order to determine interim settlement prices for cleared financial instruments that require discounting for fair valuation.

A process for financing and interest rate price discovery utilizing a centrally-cleared derivative is provided. Criteria are bid and/or offered with respect to enumerated amounts. The criteria can be prices or interest rates. The interest rate can be an overnight and other term interest rates, forward interest rates, and combinations thereof. Bids and offers are matched at the same criteria rate. Each matched bid and offer is assigned at least one derivative at a price derived from the matched criteria. The derivative is centrally cleared.

### BRIEF DESCRIPTION OF THE DRAWINGS

FIG. 1 is a flow-chart setting forth an example of an interest rate received and paid by the parties when trading at a price that is some discount to the terminal value of the financial instrument.

FIG. 2 is a flow-chart setting forth an example of a price of instruments delivered to parties that have traded at an interest rate rather than a price discount to the terminal value.

FIG. 3 is a graph showing the payoff of European call option with strike 50.

FIG. 4 is a graph showing the payoff of European put option with strike 50.

FIG. 5 is a graph showing the payoff of an option combination of the European call and put options of FIGS. 3 and 4 with a “risk reversal”.

FIG. 6 is a non-limiting example of a hardware infrastructure that can be used to run a system that implements electronic clearing and settling of the financial instrument of the present invention.

### DETAILED DESCRIPTION OF PREFERRED EMBODIMENTS

In accordance with the principles of the present invention, a process for financing and interest rate price discovery utilizing a centrally-cleared derivative is provided. The resulting interest rates can be referenced as a benchmark to adjust certain cleared financial instruments to better compare to their OTC counterparts, to better determine the values of such financial instruments. The present invention can be used to manage overnight and other term interest rate risk, and forward interest rate risk.

In accordance with the principles of the present invention, the terminal value of the derivative or combination of derivatives, in whatever form or forms, will be such that the seller of the derivative will effectively pay a predetermined interest rate, and the buyer of the derivative will effectively receive a predetermined interest rate for a specified time period. To accomplish this, the derivative or combination of derivatives assigned to parties will be discounted to a defined terminal value. For example, in the case of a combination of binary call and put options on a specified future or security, struck at any price, in accordance with the present invention, the terminal value of such combination of options can be set to a particular value, for example 100. Market participants can trade this combination of options at some discount to 100 such that, taking into account the expiration date of the options, the party buying the options will effectively receive the interest rate implied by the difference between the aggregate price of the combination of options and 100, and the party selling the options will effectively pay such implied interest rate. The terms of this combination of options will be such that together the combination must have a value of 100 at expiry.

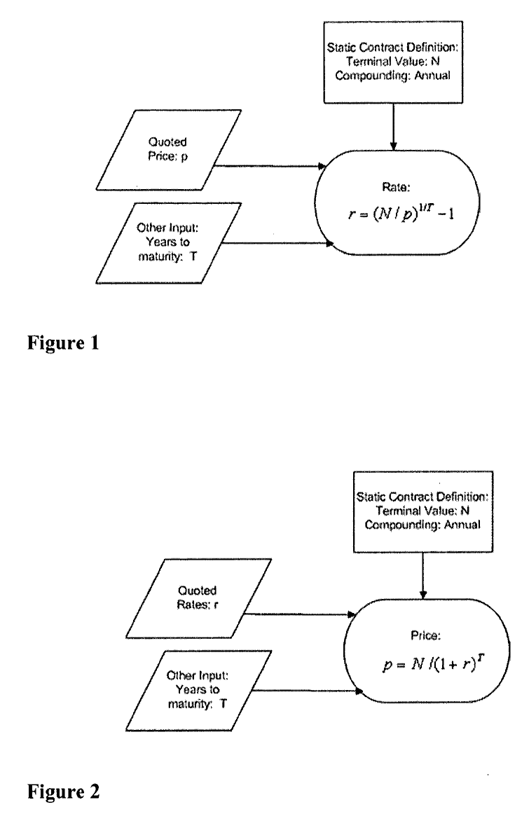

The derivative or combination of derivatives of the present invention can trade either at a price or as a rate. The interest rate can be expressed with any compounding method (simple, daily, quarterly, annual, etc.) and day count conventions (30/360, actual/360, actual/actual, etc.) on which the market participants agree. If the derivative is traded in price terms, an interest rate can be implied by the price, as seen in FIG. 1. For example, assuming the terminal value is 100 and the traded price is p for a derivative that has n days to expiration, the corresponding daily-compounded interest rate with actual/actual day count convention is

$$365 ( {( \frac{100}{p} )}^{1 / n} - 1 ) ;$$

or

$${( \frac{100}{p} )}^{365 / n} - 1 ,$$

if the interest rate is compounded annually.

If the derivative or combination of derivatives of the present invention is traded as an interest rate rather than as a price, the exchange or clearinghouse can assign a price to the derivative(s) according to the traded rate, as seen in FIG. 2. For example, assuming the terminal value is 100 and the traded interest rate is r for a derivative that has n days to expiration, the corresponding price is

$$100 {( 1 + \frac{r}{365} )}^{- n} ,$$

if the interest rate is compounded daily and the day count convention is actual/actual; or 100(1+r)^{-n/365}, if compounded annually.

The terms of the interest rates bid and/or offered will also be specified in advance, including for example the day count convention, the compounding convention, and the business day convention. Day count convention is a system used to determine the number of days between two dates; the compounding convention is the frequency at which the interest is reinvested; and the business day convention a system for determining how non-business days are treated. For example, the overnight rate auction on a Friday could actually be a three-day rate on a regular weekend, applying to Friday, Saturday, and Sunday; on other days that are not followed by a holiday, the overnight rate would be a one-day, overnight rate.

The following Examples 1 and 2 are non-limiting examples of derivatives that can be utilized to provide the funding rate of a process for financing and interest rate price discovery utilizing a centrally-cleared derivative in accordance with the principles of the present invention.

### EXAMPLE 1

This example shows that binary options that can be utilized to provide the funding rate of a process for financing and interest rate price discovery of the present invention.

A binary option is a type of option where the payoff is either some fixed amount or zero. For example, the Chicago Board Options Exchange (CBOE), 400 South LaSalle Street, Chicago, Ill. 60605, offers binary options on the Standard and Poor's S&P 500 index (SPX). The buyer of a binary call option receives $100 if the underlying index settles at or above the strike price at the expiration; the buyer of a binary put option receives $100 if the underlying index settles below the strike price at expiration.

A derivative of the present invention can be constructed as the combination of a binary call option and a binary put option with the same strike. This combination generates a deterministic payoff, i.e., $100 at the expiration. Upon purchase of the derivative of the present invention, the buyer pays the premium upfront and receives $100 at expiration. If the premium is 95 when the derivative of the present invention has one year to expiration, the buyer of the option combination in essence lends $95 for a one-year term at an interest rate of 5.26% (=(100-95)/95), compounded annually.

A derivative of the present invention can also be quoted and traded in yields with certain compounding and day count conventions. Assuming annual compounding, if two parties agree to transact a derivative of the present invention at a rate of 5.26%, the exchange or clearinghouse causes the buyer to pay $95 to the seller (=100/(1+5.26%)). The exchange or clearinghouse delivers to each party a derivative in accordance with this example, i.e., a binary call and a binary put. Assuming the parties hold these derivatives until expiration, because of the deterministic nature of this combination of options, the exchange or clearinghouse will cause the seller to pay $100 to the buyer at expiration.

### EXAMPLE 2

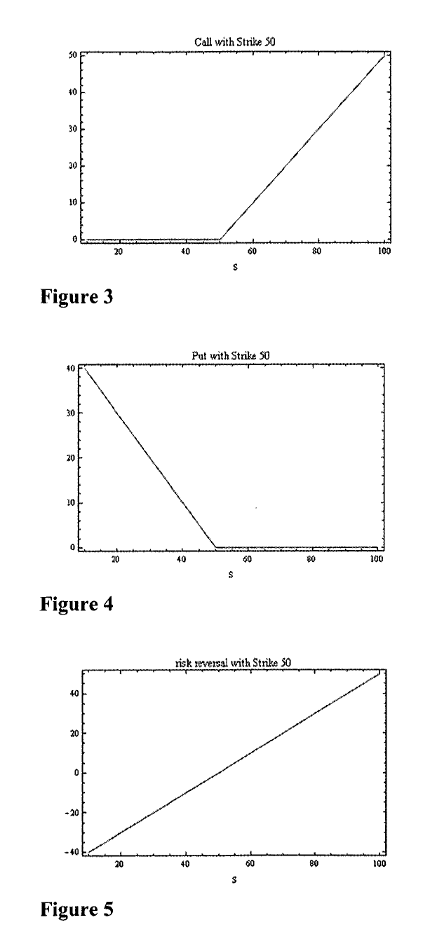

This example shows that European call and put options can be utilized to provide the funding rate of a process for financing and interest rate price discovery utilizing a centrally-cleared derivative in accordance with the principles of the present invention. FIGS. 3 and 4 show the payoff of European call and put option with strike 50. An option combination consisting of buying a call and selling a put is called a “risk reversal”. When the two options of the risk reversal have same strike, this type of option combination generates a payoff equivalent to the linear function of the underlying derivative, as seen in FIG. 5.

A “box” refers to a combination of buying a risk reversal at one strike and selling a risk reversal at a different strike. A “box” has a deterministic payoff equal to the difference between the two strikes at expiration. For example, a “box” with strikes 50-150 is equivalent to buying a risk reversal with strike 50 and selling a risk reversal with strike 150, and the payoff of this combination is 100 at expiration.

A derivative of the present invention can be designed by fixing the strikes of two risk reversals, for example, 50 and 150. A buyer of this derivative will receive 100 at expiration and pay a premium upfront. Similar to the previous example, this derivative can also be traded and quoted in either price or yield terms, with certain compounding and day count conventions.

Again, the foregoing are non-limiting examples of derivatives that can be utilized to provide the funding rate of a process for financing and interest rate price discovery utilizing a centrally-cleared derivative in accordance with the principles of the present invention.

Without limitation, the price or rate criteria could be determined through any price discovery process including but not limited to: an auction process; a volume-weighted average price or rate; a central limit order book trading process—whether electronic, by telephone or open outcry; a “trade-at-settlement” process; or any other mechanism. The rules of the auction or other price discovery process would be set in advance.

It is envisioned that an exchange or clearinghouse would specify a price discovery process to market participants. In one embodiment of the present invention, an exchange or clearinghouse could conduct for example an auction to discover and set the overnight rate. Upon the conclusion of the trading, the exchange or clearinghouse would determine the applicable rate or price, determining the parties that were matched, assign a derivative or a combination of derivatives to the matched participants, and facility the transfer of funds between matched participants.

In another embodiment of the present invention, instead of the auction being conducted at a rate, an auction could be conducted for a price of a derivative of a deterministic value, and a rate can be implied from the results of such auction.

The following is a non-limiting example of price discovery that can be utilized in a process for financing and interest rate price discovery utilizing a centrally-cleared derivative in accordance with the present invention.

### EXAMPLE 3

A derivative implemented in accordance with the present invention can have frequent expirations in order to meet short-term financing needs. For example, on any given day market participants can trade derivatives with one day to expiration. The trading price or yield reflects the overnight financing cost of the participants. Other than matching the trades through a central limit order book and an exchange matching engine, a public offering auction structured such as for example a Dutch auction can be used to facilitate the trades.

The derivative for which the auction occurs has a terminal value of 100. If the derivative is quoted in price, and the announced price is 99.997, then all bids higher than this price will be accepted. A buyer of this derivative will in essence lend $99.997 for every $100 notional overnight and be repaid $100 the next day. The trades can also be quoted in terms of overnight interest rate. For example, if daily compounding and actual/actual day count are used, the price of 99.997 is equivalent to a rate of 1.95% (=(100/99.997−1)*365). All the calculations above can be adjusted for weekends and holidays.

The exchange or clearinghouse can then use the resulting overnight rate as a reference rate for its centrally-cleared interest-rate swaps or interest-rate swap futures. In addition, through this process matched market participants have effectively managed their cash balances.

Again, the foregoing is a non-limiting example of price discovery that can be utilized in a process for financing and interest rate price discovery utilizing a centrally-cleared derivative in accordance with the principles of the present invention.

Upon the conclusion of matching as described above, the exchange or clearinghouse would conduct a settlement process. This would involve several steps. The exchange or clearinghouse would determine which market participants were matched and at what price or interest rate in the price discovery process. Then, the exchange or clearinghouse would assign to each matched participant a derivative or combination of derivatives reflecting the appropriate economics. These instruments or combination of instruments could be freely tradable. Finally, the exchange or clearinghouse would require and facilitate the collection and payment of amounts matched in the price discovery process. When used herein, price discovery process is meant in its broadest sense and includes but is not limited to straight matching of bids and offers, auctions of any sort, average pricing methodologies (e.g. volume average weighting), straight averaging, and other price discovery methodologies.

The present invention is not limited and can be cleared on any clearinghouse, traded on any exchange or trading platform, regardless of whether located in the United States or abroad, traded through any price discovery process, including a central limit order book, private negotiation, an auction, traded in currencies other than United States dollars, and traded in many forms of derivatives, including a single option, a combination of options, or other type of derivative. When used herein, the terms exchange and trading platform refer broadly to a marketplace in which securities, commodities, derivatives, and other derivatives can be traded, and include, but are not limited to, designated contract markets, exempt boards of trade, derivatives clearing organizations, securities exchanges, swap execution facilities, electronic communications networks, and the like.

According to the principles of the present invention, in order to publish daily and terminal settlement values a clearinghouse, exchange, futures commission merchant or other market participant may use computers with software specifically designed for this purpose. The computation of the terminal value in accordance with the present invention is iterative and complex, and special software is required for this purpose. This software may be linked to a centralized marketplace via data lines, networks or the Internet, so that the prices are published in a seamless manner. The clearing house may store the daily prices for each derivative in existence at any given moment in a database that can be electronically published to the marketplace.

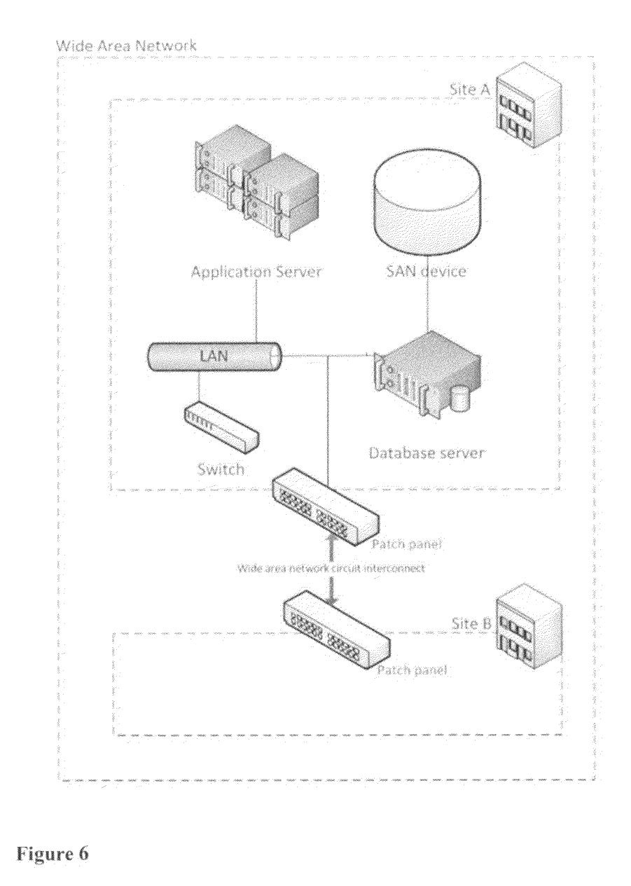

Referring to FIG. 6, a non-limiting example of a high-level hardware implementation can used to run a system of the present invention is seen. The infrastructure should include but not be limited to: wide area network connectivity, local area network connectivity, appropriate network switches and routers, electrical power (backup power), storage area network hardware, server-class computing hardware, and an operating system such as for example Redhat Linux Enterprise AS Operating System available from Red Hat, Inc, 1801 Varsity Drive, Raleigh, N.C.

The clearing and settling and administrative applications software server can run for example on an HP ProLiant DL 360 G6 server with multiple Intel Xeon 5600 series processors with a processor base frequency of 3.33 GHz, up to 192 GB of RAM, 2 PCIE expansion slots, 1 GB or 10 GB network controllers, hot plug SFF SATA drives, and redundant power supplies, available from Hewlett-Packard, Inc, located at 3000 Hanover Street, Palo Alto, Calif. The database server can be run for example on a HP ProLiant DL 380 G6 server with multiple Intel Xeon 5600 series processors with a processor base frequency of 3.33 GHZ, up to 192 GB of RAM, 6 PCIE expansion slots, 16 SFF SATA drive bays, an integrated P410i integrated storage controller, and redundant power supply, available from Hewlett-Packard.

While the invention has been described with specific embodiments, other alternatives, modifications, and variations will be apparent to those skilled in the art. Accordingly, it will be intended to include all such alternatives, modifications, and variations set forth within the spirit and scope of the appended claims.

What is claimed is:

1. A method for financing and/or interest rate price discovery comprising:
bidding and/or offering criteria with respect to enumerated amounts ;
electronically matching a bid and an offer at the same criteria on at least one processor;
electronically assigning to each matched bid and offer at least one derivative at a price derived from the matched criteria on at least one processor; and
electronically centrally clearing the derivative on at least one processor.

2. The method for financing and/or interest rate price discovery of claim 1 further including electronically bidding and/or offering an interest rate with respect to enumerated amounts on at least one processor.

3. The method for financing and/or interest rate price discovery of claim 2 further including bidding and/or offering term interest rate with respect to enumerated amounts.

4. The method for financing and/or interest rate price discovery of claim 3 further including bidding and/or offering an overnight interest rate with respect to enumerated amounts.

5. The method for financing and/or interest rate price discovery of claim 2 further including electronically assigning to each matched bid and offer at least one derivative at a price derived from the matched interest rate on at least one processor.

6. The method for financing and/or interest rate price discovery of claim 1 further including electronically bidding and/or offering a price with respect to enumerated amounts on at least one processor.

7. The method for financing and/or interest rate price discovery of claim 1 further including bidding and/or offering one or more forward rates with respect to enumerated amounts on at least one processor.

8. The method for financing and/or interest rate price discovery of claim 1 further including bidding and/or offering with respect to enumerated amounts from the group consisting of an overnight rate, a day rate, a weekly rate, a monthly rate, a three-month rate, a six-month rate, a nine-month rate, a one-year rate, 10-year rate, and combinations thereof.

9. The method for financing and/or interest rate price discovery of claim 1 further including creating a future on the derivative.

10. The method for financing and interest rate price discovery of claim 9 further including creating a future on the derivative that is cash settled.

11. The method for financing and/or interest rate price discovery of claim 9 further including creating a future on the derivative that is physically delivered.

12. The method for financing and/or interest rate price discovery of claim 1 further including creating an option on the derivative.

13. The method for financing and/or interest rate price discovery of claim 1 further including determining the criteria through an auction process.

14. The method for financing and/or interest rate price discovery of claim 13 further including determining the criteria through a Dutch auction process.

15. The method for financing and/or interest rate price discovery of claim 1 further including determining the criteria through a value weighted average price.

16. The method for financing and/or interest rate price discovery of claim 1 further including determining the criteria through a central limit order book trading process.

17. The method for financing and/or interest rate price discovery of claim 1 further including determining the criteria through a trade at settlement process.

18. The method for financing and/or interest rate price discovery of claim 1 further including determining the criteria from a group comprising day count convention, compounding convention or business day convention.

19. The method for financing and/or interest rate price discovery of claim 1 further including settling the terminal value of the derivative to a predefined value.

20. The method for financing and/or interest rate price discovery of claim 1 further including electronically assigning to each matched bid and offer a combination of derivatives at a price derived from the matched criteria on at least one processor.

21. The method for financing and/or interest rate price discovery of claim 1.12 further including assigning a side of an option to one of the matched bid and offer and an offsetting side of the option to the other matched bid or offer.

22. The method for financing and/or interest rate price discovery of claim 21 further including assigning a side of a binary option to one of the matched bid and offer and an offsetting side of the binary option to the other matched bid or offer.

23. The method for financing and/or interest rate price discovery of claim 20 further including assigning a side of an option combination to one of the matched bid and offer and an offsetting side of the option combination to the other matched bid or offer.

24. The method for financing and/or interest rate price discovery of claim 23 further including assigning a side of a risk reversal option combination to one of the matched bid and offer and an offsetting side of the risk reversal option combination to the other matched bid or offer.

25. The method for financing and/or interest rate price discovery of claim 23 further including assigning a side of a box option combination to one of the matched bid and offer and an offsetting side of the box option combination to the other matched bid or offer.

26. The method for financing and/or interest rate price discovery of claim 23 further including assigning a side of binary option combination to one of the matched bid and offer and an offsetting side of the binary option combination to the other matched bid or offer.

27. The method for financing and/or interest rate price discovery of claim 1 further including selecting the at least one microprocessors from the group comprising one processor, more than one processor, and combinations thereof.

28. A general-purpose digital computer programmed to carry out a series of steps, the series of steps for financing and/or interest rate price discovery comprising:
bidding and/or offering criteria with respect to enumerated amounts;
electronically matching a bid and an offer at the same criteria on at least one processor;
electronically assigning to each matched bid and offer at least one derivative at a price derived from the matched criteria on at least one processor; and
electronically centrally clearing the derivative on at least one processor.

29. A financial instrument obtained by a process, the process comprising:
receiving bid and/or offer criteria with respect to enumerated amounts;
matching a bid and an offer at the same criteria;
assigning to each matched bid and offer at least one derivative at a price derived from the matched criteria; and
centrally clearing the derivative.

30. A financial instrument comprising:
means for receiving bid and/or offer criteria with respect to enumerated amounts;
means for matching a bid and an offer at the same criteria;
means for assigning to each matched bid and offer at least one derivative at a price derived from the matched criteria; and
means for centrally clearing the derivative.
